(19) United States
(12) Patent Application Publication
(10) Pub. No.: US 2008/0274255 A1
(43) Pub. Date: Nov. 6, 2008

(54) Process for Producing Ready-to-Eat Chow Mein (Fried Noodle)

(75) Inventors: Yoshiyuki Imanishi, Osaka (JP); Toshiaki Sonoda, Osaka (JP); Hirotake Yamada, Osaka (JP)

Correspondence Address: QUINN EMANUEL;KODA & ANDROLIA, 865 S. FIGUEROA STREET, 10TH FLOOR, LOS ANGELES, CA, 90017, US

(73) Assignee: ACECOOK CO., LTD.

(21) Appl. No.: 10/571,732

(22) PCT Filed: May 31, 2005
(86) PCT No.: PCT/JP2005/009957

§ 371 Date: Mar. 14, 2006

(30) Foreign Application Priority Data
Oct. 27, 2004 (JP) 2004-311788

(51) Int. Cl. A23L 1/16

(52) U.S. Cl. 426/557

(57) ABSTRACT

The present invention provides a process for producing ready-to-eat chow mein, which browns a mass of fried noodles so as to be able to always constantly and reliably afford elastic feeling and fragrant flavor as if it were baked on a hot iron plate. Floor, starch, salt, water and the like are mixed to make a material. The material is kneaded. The thus kneaded material is extended and rolled to a predetermined thickness to form a noodle blank. This noodle blank is cut to a predetermined width and waved to form lines of noodles. These lines of noodle are converted to α-state and then molded to a predetermined shape. Thereafter, they are oil fried to make a mass of noodles. The oil fried mass of noodles is baked to brown its surface until the surface of the mass of noodles has a temperature increased up to 150 degrees C. to 240 degrees C.

It bakes a surface of the mass of ready-to-eat oil fried noodles molded into a predetermined shape to brown it until the surface has a temperature increased up to 150 degrees C. to 240 degrees C.

### TECHNICAL FIELD

The present invention concerns a process for producing browned ready-to-eat chow mein.

### BACKGROUND ART

Conventionally, commercially available oil fried ready-to-eat chow mein is usually prepared by: mixing floor, starch, table salt, brackish water, water and the like and kneading the thus mixed material; extending this material to 2 sheets of wide noodle blank; combining them into one sheet; and rolling this sheet to a predetermined thickness through several sets of rolls. Subsequently, this noodle blank is cut to a predetermined width by a cutter and waved to form creped lines of noodle peculiar to the ready-to-eat chow mein. Next, the creped lines of noodle are steamed by a steamer and then the steamed lines of noodle are cut to a desired size. The cut and steamed lines of noodle are stuffed into a mold framework of a fixed shape and are molded to a predetermined form. Thereafter, the molded lines of noodle are oil fried.

The thus produced ready-to-eat chow mein is returned to its original state by pouring boiling water and is got rid of the boiling water. Then it is mixed with sauce for chow mein and dried green layer powder is sprinkled thereon to eat. However, it lacks such a fragrance as the original chow mein baked on a hot iron plate has.

Then in order to apply such a fragrance as occurring when baked on the hot iron plate, there was proposed a process for making ready-to-eat chow mein which bakes fried ready-to-eat chow mein to brown by a gas burner, infrared rays or the like (for instance, see Patent Literature 1).

Patent Literature Patent Public Disclosure No. 2002-119234

### DISCLOSURE OF THE INVENTION

### Problem the Invention Attempts to Solve

However, like the above-mentioned process for making ready-to-eat chow mein, only baking the fried ready-to-eat chow mein with a gas burner or the like to brown its surface can hardly afford such a feeling (the surface of the chow mein hardened and elastic enough to feel comfortable and tasty when eating) experienced when we eat the partly browned chow mein appearing upon baking it on the hot iron plate. Further, it mostly browned the surface too much or insufficiently with the result of failing to acquire the intended fragrance.

The present invention has been created so as to solve the above-mentioned problem. And it has an object to provide a process for producing a ready-to-eat chow mein which makes the ready-to-eat chow mein constant in quality by finding out a noodle's surface temperature optimum for browning the surface of the ready-to-eat fried mass of noodles so that it can always stably and reliably apply such feeling and fragrance as experienced when baking it on the hot iron plate.

### Means for Accomplishing the Object

The process for producing ready-to-eat chow mein according to the present invention is characterized by baking a surface of a ready-to-eat fried mass of noodles molded into a predetermined shape up to 150 degrees to 240 degrees C. so as to brown it.

In this case, the ready-to-eat fried mass of noodles is prepared by mixing floor, starch, table salt, water and the like and kneading the thus mixed material, extending this material and rolling it to a predetermined thickness to form a noodle blank, cutting this noodle blank to a predetermined width and waving it to form creped lines of noodle, converting these creped lines of noodle to α-state and then molding them to a predetermined shape, and thereafter oil frying them.

### EFFECT OF THE INVENTION

The ready-to-eat chow main was prepared by baking the fried mass of noodles to brown its surface until its surface temperature comes to 150 degrees C. to 240 degrees C. gives such an elastic feeling and fragrance as experienced when baking it on the hot iron plate. When the fried mass of noodles has its surface temperature baked only to below 150 degrees C., it is insufficiently browned to result in failing to afford fragrance and comfortable elastic feeling. On the other hand, when the fried noodle has its surface temperature baked to over 240 degrees C., it has its surface excessively browned to result in failing to present good appearance and further producing smell of something burning in the aspect of flavor. Thus not preferable.

### BRIEF DESCRIPTION OF THE DRAWINGS

FIG. 1 is a graphic view showing the relationship between the baking time at the atmospheric temperature of 220 degrees C. and the surface temperature of the noodle.

FIG. 2 is a graphic view showing the relationship between the baking time at the atmospheric temperature of 280 degrees C. and the surface temperature of the noodle.

FIG. 3 is a graphic view showing the variation of the acid number with the elapse of time by baking

### MOST PREFERRED EMBODIMENT FOR PUTTING THE INVENTION INTO PRACTICE

A process for producing ready-to-eat chow mein (fried noodle) according to the present invention first prepares fried noodle. The fried noodle is prepared in a usual way. Ordinarily, the starting materials of floor, starch, table salt, blackish water, water and the like are mixed by a mixer and the thus mixed materials are kneaded. This forms the mesh structure of the gluten. The mixing time is about 15 to 20 mins. Next, the kneaded material is extended to two sheets of wide noodle blank, which are combined into one sheet. Then the sheet is rolled to a thickness of about 1 mm through several sets of rolls. Subsequently, the noodle blank is cut to a predetermined width by a cutter and waved to form creped lines of noodle, peculiar to the ready-to-eat chow mein, so that the subsequent steps can be effectively conducted. Next, the creped lines of noodle are steamed by a continuous steamer to covert them to α-state. Commonly, they are steamed up within 1 to 2 mins. with steam of 100 degrees C. Subsequently, loosening is applied so that the lines of noodle can be easily loosened when they are returned to the original state with boiling water. Most of the noodles packaged into cups are loosened noodles. Many of the noodles packed in bags are two-folded noodles which don't undergo the loosening step.

Then these steamed noodles are cut to 20 to 70 cm so that they come to have a weight for eating once. The cut and steamed noodles are stuffed into a mold framework of a fixed form and are molded into a predetermined shape. The molded noodles are passed through oil of 120 to 160 degrees C. so as to dehydrate and fix (drying step). Finally, in order to prevent the quality reduction of the fat and oil contained in the noodles and that of the attached soup, they are instantaneously cooled to 30 to 40 degrees C. (cooling step).

The fried mass of noodles of predetermined shape obtained during the above steps is transferred to a baking step to brown its surface after the drying step or the cooling step. During this baking step, the fried mass of noodles is baked until it has its surface temperature raised to 150 degrees C. to 240 degrees C., more preferably to 180 degrees C. to 200 degrees C. by a heat source such as a burner and an oven, so as to brown it.

The mass of noodles can afford fragrant flavor by baking it to brown its surface after it has been fried with oil. Particularly, it can give such a feeling as the partly browned noodles present when they are baked on a hot iron plate. In other words, it can give a hardened and elastic feeling because its surface loses moisture. Further, it is mixed with unbaked noodles to offer the same feeling as if it were baked on the hot iron plate. Additionally, it produces peculiar fragrant flavor not obtained with the unbaked ready-to-eat chow mein (fried noodle).

Since the noodles fried with oil contains less water, they can be browned merely by baking them at a relatively low temperature and for a short period of time. Besides, they have a uniform shape by being dried, so that they can have their surface evenly browned to present excellent outer appearance and delicious feeling for eyes.

The baking conditions are irrespective of the temperature of the mass of noodles before baking, the heating temperature and the baking time. The mass of noodles can have its surface browned by heating the surface of the mass of noodles to at least 150 degrees C. More preferably, if the mass of noodles is baked by having its surface heated to 180 degrees C. to 200 degrees C., it presents better outer appearance and flavor. However, in the event that the mass of noodles is baked by heating its surface to above 240 degrees C., the mass of noodles has its surface excessively browned to result in failing to afford good outer appearance and flavor.

A baking test of the mass of noodles fried with oil was carried out under the following baking conditions and in the following baking way:

### (Baking Conditions)

Heat source; Shubunk burner made by Linnai Co., Ltd.
Burner temperature; about 700 degrees C.
Distance from the burner to the fried mass of noodles; 75 mm
Atmospheric temperature in the vicinity of the surface of the mass of noodles; 220 degrees C.
Temperature of the mass of noodles before baking; about 30 degrees C.
Measurement of the surface temperature of the mass of noodles; Measured by a radiation thermometer of Leitec.

### (Baking Way)

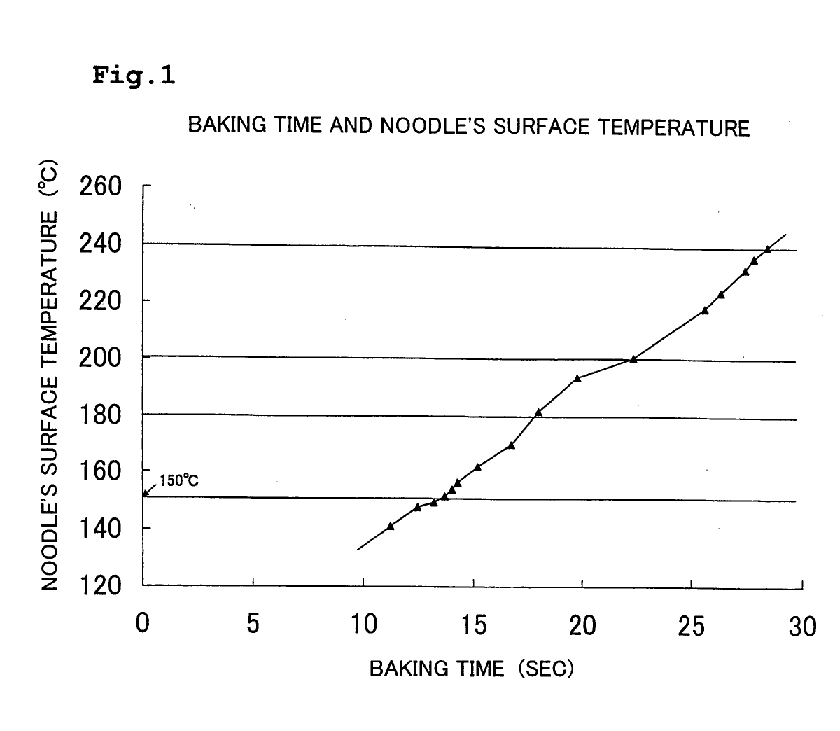

The fried mass of noodles is baked by applying the flame of the burner from thereabove to heat the surface of the mass of noodles. While the temperature of the burner is kept constant, the surface temperature (how the mass is browned) of the mass of noodles was measured by changing the heating time. The result of the measurements includes the baking time and the surface temperature of the mass of noodles the relationship between which is shown in FIG. 1.

Some tens of panelists made sensuous evaluation for every mass of noodles obtained by the baking test. With the surface of the mass of noodles having a temperature of below 150 degrees C., it was not sufficiently browned to result in failing to offer good elastic feeling and flavor. However, with the temperature increased to about 150 degrees C., it began to be browned to produce elastic feeling and fragrant flavor. Particularly, when the mass of noodles has its surface temperature heated within a range of 180 to 200 degrees C., it was most ideally browned to offer a good outer appearance (degree of the brownish) and was excellent in feeling and fragrant flavor. Thus this range is optimum surface temperature of the mass of noodles. With the surface temperature of the mass of noodles exceeding 240 degrees, it was excessively browned to result in a sensuous evaluation that not only bad outer appearance was presented but also smell which occurs when something is burnt was too much produced.

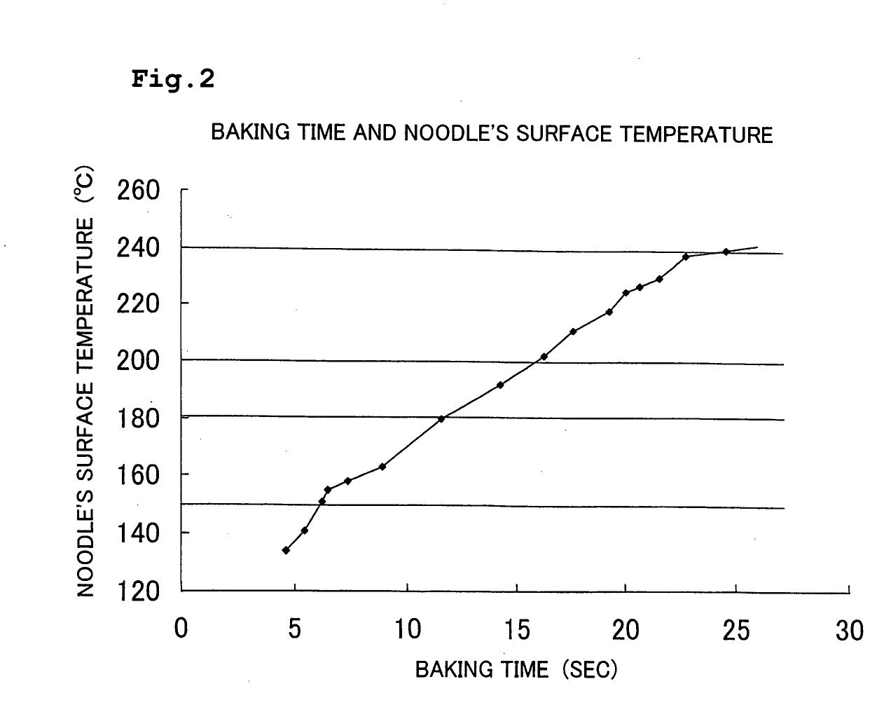

Further, as shown in FIG. 2, the baking test was conducted under the same conditions as those mentioned above except that the atmospheric temperature around the mass of noodles was 280 degrees.

In this case, the same sensuous evaluation was obtained.

It can be seen from the graphic view of FIG. 1 that the mass of noodles can be baked so as to have its surface temperature increased to 150 degrees C. when it is baked for 13 to 14 seconds under the above-mentioned baking conditions at a temperature of 220 degrees C. in the atmosphere therearound. When it is baked for 28 to 29 seconds, the mass of noodles can be baked so as to have its surface temperature increased to 240 degrees C. It can be further seen that when the mass of noodles is baked for 18 to 23 seconds, it can be baked to have its surface temperature up to the most optimum temperature of 180 degrees C. to 200 degrees C. It can be seen from the graphic view of FIG. 2 that the mass of noodles can be baked so as to have its surface temperature increased to 150 degrees C. when it is baked for about 6 seconds at a temperature of 280 degrees C. in the atmosphere therearound. When it is baked for about 25 seconds, the mass of noodles can be baked so as to have its surface temperature increased to 240 degrees C. It can be further seen that when the mass of noodles is baked for 12 to 16 seconds, it can be baked to have its surface temperature up to the most optimum temperature of 180 degrees C. to 200 degrees C. In any case, since the oil fried noodle has less content of moisture, it can be browned only by baking it at a relatively low temperature and for a relatively short period of time.

### (Test for Confirming Preservability)

Two products were prepared. One was prepared by baking an oil fried noodle by Shbunk burner so as to have its surface increased up to 150 degrees C. to 240 degrees C. to brown it. The other was prepared without baking. Both of the products were preserved for a predetermined period of time to confirm their quality.

The respective noodles were set in the shapes of product and were preserved for 5 months (edible term) at room temperature of 20 degrees C. The oil and fat content in each of the noodles was extracted to measure the acid number with the elapse of time. Table 3 shows the variation of the acid number with the elapse of time.

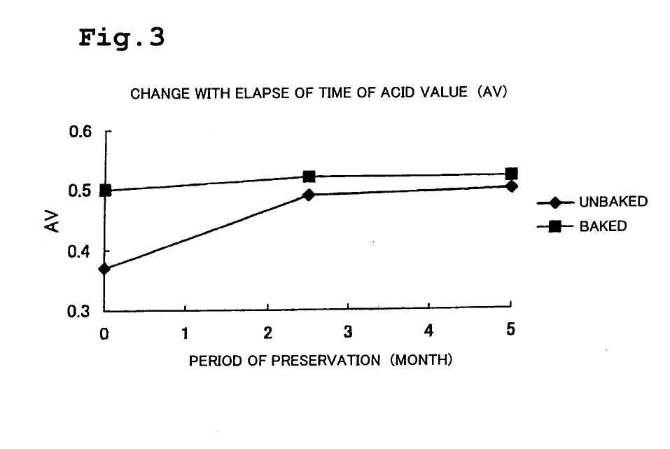

Apparently from the graphic view of FIG. 3, the acid number increases more by baking than by not baking. Although it can be seen that the baking somewhat exerts influence, each of them has an acid number not more than 1.5 of JAS standard and not more than 3 of the Food Hygiene Law. Therefore, it has been judged the baking does not exert any substantial influence on the product.

1. A process of producing ready-to-eat chow mein (fried noodle) comprising the steps of molding a ready-to-eat mass of noodles into a predetermined shape: oil frying the mass of noodles; and baking the oil fried mass of noodles to have its surface temperature increased up to 150 degrees C. to 240 degrees C. to brown the surface of the mass of noodles.

2. The process of producing ready-to-eat chow mein as set forth in claim 1, wherein the ready-to-eat fried mass of noodles is prepared by the steps of:
mixing floor, starch, salt, water and the like to make a material and kneading the material;
extending and rolling this material to a predetermined thickness to form a noodle blank;
cutting the noodle blank to a predetermined width and waving it to form lines of noodle;
converting these lines of noodle to α-state and then molding them to a predetermined shape; and
oil frying them.
